(19) United States
(12) Patent Application Publication
(10) Pub. No.: US 2009/0141757 A1
(43) Pub. Date: Jun. 4, 2009

(54) OPTICAL AMPLIFIERS

(75) Inventors: Andrew John Parker, Paignton (GB); Jonathan Stuart Drake, Paignton (GB); Michael Biddle, Gloucestershire (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: BOOKHAM TECHNOLOGY PLC, Northamptonshire (GB)

(21) Appl. No.: 12/267,644

(22) Filed: Nov. 10, 2008

(30) Foreign Application Priority Data
Nov. 15, 2007 (GB) 0722426.4

(51) Int. Cl. H01S 3/04; H01S 3/00

(52) U.S. Cl. 372/34; 359/341.1

(57) ABSTRACT

An optical amplifier comprises an optical fibre, a pump laser for optically pumping the optical fibre to amplify an optical signal, a TEC 1 for cooling the pump laser on receipt of a cooling current, a temperature sensor 2 for monitoring the temperature of the amplifier housing; and a control circuit 3 for controlling the cooling current in dependence on a sensing output from the temperature sensor 2, so as to maintain the temperature of the pump laser at a temperature set point. The control circuit 3 is configured (i) to maintain the temperature of the pump laser at a first temperature set point within a predetermined temperature range of the amplifier, and (ii) to maintain the temperature of the pump laser at a second temperature set point, higher than the first temperature set point, when the sensing output from the temperature sensor 2 exceeds a threshold value. The feature that the temperature set point is raised to a higher level when the temperature of the pump laser goes above a preset level reduces the amount of self-heating of the pump laser, and thus prevents a thermal runaway situation.

This invention relates to optical amplifiers and is concerned more particularly, but not exclusively, with erbium doped fibre amplifiers (EDFAs).

### BACKGROUND OF THE INVENTION

EDFAs are designed to amplify optical signals with a gain controlled by the drive currents applied to one or more optical pump lasers for supplying pump light to the erbium doped fibre (EDF) loop. Commonly the optical pump laser is cooled by a thermo-electric cooler (TEC) driven by a cooling current. However, when the amplifier is operating at high temperatures, the cooling current that is required to be supplied to the TEC becomes high, and this can result in substantial self-heating of the cooler due to the current passing through it. This self-heating must then in turn be overcome by increasing the level of cooling by the TEC and hence the cooling current, and this can result in thermal runaway, due to the continuously increasing TEC current requirement to contain the temperature of the pump laser leading to the need for more cooling and hence a further increase in the TEC current, etc. so that the cooling feedback mechanism goes out of control. At this point an EDFA controller may be instructed to turn off the pump laser to protect it, but this has the disadvantageous effect of disrupting the signal traffic being conducted by the amplifier since the amplifier stops providing gain. Furthermore, when the cooling current is controlled by an external control circuit sensing the temperature of the amplifier being controlled, the situation may be reached whereby the extra heating induced by the increased drive current causes thermal runaway such that the increased heat generated by the cooling current cannot be overcome by the cooling applied by the cooler. In this case the heat of the pump laser can increase to such an extent that the solder holding the laser chip to the cooler melts and the laser chip misaligns relative to the optical fibre. If this occurs the optical fibre link within which the optical amplifier is used experiences signal attenuation and/or increased noise.

It is an object of the invention to control the cooling of the pump laser to prevent thermal runaway caused by self-heating of the cooler.

### SUMMARY OF THE INVENTION

According to the present invention an optical amplifier comprising an optical fibre; a pump laser for optically pumping the optical fibre to amplify an optical signal; a cooler for cooling the pump laser on receipt of a cooling current; a temperature sensor for monitoring a temperature of the amplifier; and a control circuit for controlling the cooling current in dependence on a sensing output from the temperature sensor, so as to maintain the temperature of the pump laser at a temperature set point; wherein the control circuit is configured (i) to maintain the temperature of the pump laser at a first temperature set point within a predetermined temperature range of the amplifier, and (ii) to maintain the temperature of the pump laser at a second temperature set point, higher than the first temperature set point, when the sensing output from the temperature sensor exceeds a threshold value.

In this case, the feature that the temperature set point is raised to a higher level when the temperature of the pump laser goes above a preset level reduces the amount of self-heating of the pump laser, and thus prevents a thermal runaway situation.

In a possible variant the control circuit is further configured to vary the temperature of the pump laser in accordance with a variable temperature set point when the sensing output from the temperature sensor exceeds the threshold value, until the temperature of the pump laser reaches the second temperature set point. Thus, instead of the temperature set point changing substantially instantly in one step from the first temperature set point to the second temperature set point when the sensing output from the temperature sensor exceeds the threshold value, the temperature set point can gradually increase from the first temperature set point to the second temperature set point over a period of time.

The invention also provides a method of controlling an optical amplifier having an optical fibre, a pump laser for optically pumping the optical fibre to amplify an optical signal, and a cooler for cooling the pump laser on receipt of a cooling current, the method comprising controlling the cooling current in dependence on a sensed temperature of the amplifier so as (i) to maintain the temperature of the pump laser at a first temperature set point within a predetermined temperature range of the amplifier, and (ii) to maintain the temperature of the pump laser at a second temperature set point, higher than the first temperature set point, when the sensed temperature exceeds a threshold value.

### BRIEF DESCRIPTION OF THE DRAWINGS

In order that the invention may be more fully understood, reference will now be made, by way of example, to the accompanying drawings, in which:

FIG. 1 is a block diagram of a first embodiment of the invention;

FIG. 2 is a block diagram of a second embodiment of the invention;

FIG. 3 is a graph of the TEC power dissipation against the amplifier case temperature for the cases of fixed temperature set point control and moving temperature set point control respectively; and

FIG. 4 diagrammatically illustrates two alternative arrangements for temperature set point control with case temperature.

### DETAILED DESCRIPTION OF THE DRAWINGS

Each of the embodiments of the invention to be described below is applied to an EDF (Erbium Doped Fibre) loop amplifier comprising one or more EDF loops. The or each EDF loop is supplied with pump light from a pump laser in the form of a laser diode under the control of an automatic gain control (AGC). If required more than one laser diode may be provided for pumping the or each EDF loop, and/or additional loops and associated pump laser diodes may be provided. The pump stages may be controlled in response to receipt by the AGC of electrical detection signals from input and output power detectors in the form of photodiodes and associated tap-off couplers for monitoring the input and output powers of the amplifier.

In order to maintain the temperature of the or each laser diode within an acceptable temperature range and thereby optimise the efficiency of the amplifier, the or each laser diode is mounted on a thermoelectric cooler (TEC) driven by a cooling current to cool the laser diode.

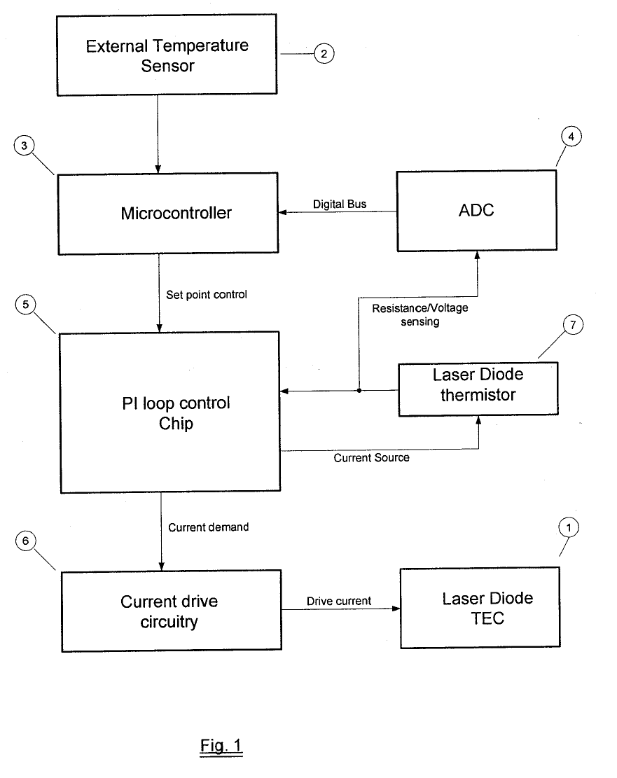

FIG. 1 diagrammatically shows the arrangement for controlling the cooling applied by the laser diode TEC 1 according to a first embodiment of the invention. In this arrangement an external temperature sensor 2 is provided for sensing the temperature of the amplifier incorporating the laser diode, and more particularly the temperature of the case containing the amplifier, which would normally have a temperature of up to 75° C. The temperature sensor 2 supplies a sensing output signal indicative of the case temperature to a microcontroller 3 that additionally receives an input signal from an analogue-to-digital converter (ADC) 4 indicative of a resistance/voltage value of the thermistor in the pump laser module that is a function of the laser temperature. The microcontroller 3 in turn supplies an output signal to a proportional integral (PI) loop control chip 5 which is designed to effect control of the cooling current supplied by current drive circuitry 6 to the TEC 1.

The PI control chip 5 supplies a current demand signal to the current drive circuitry 6 such as to maintain the temperature of the laser diode, as indicated by a laser diode thermistor 7, at a first temperature set point of 25° C. corresponding to a desired constant temperature at which the laser diode operates with optimum efficiency. This current demand signal is maintained for as long as the temperature of the amplifier case, as indicated by the sensing output signal of the temperature sensor 2, is maintained below a threshold value of 75° C. However, once the case temperature increases above 75° C., the control mode is changed so as to supply a current demand signal to maintain the temperature of the laser diode at a second temperature set point of 40° C. that is 15° C. greater than the first temperature set point. This has the result that the cooling current supplied to the TEC 1 is decreased, thus reducing the amount of self-heating and preventing a thermal runaway situation.

The PI control chip 5 incorporates an error amplifier and a PI compensator that amplifies and integrates the voltage representing the error between the set point temperature and the actual temperature of the laser diode. The output of the PI compensator controls a current source that supplies drive current to the TEC 1 within the pump laser module. The drive current can be positive to cool the pump laser or negative to heat the pump laser. The resistance of the thermistor 7 is a function of temperature so that a current injected through the thermistor 7 generates a voltage across the thermistor that is measured by the ADC 4.

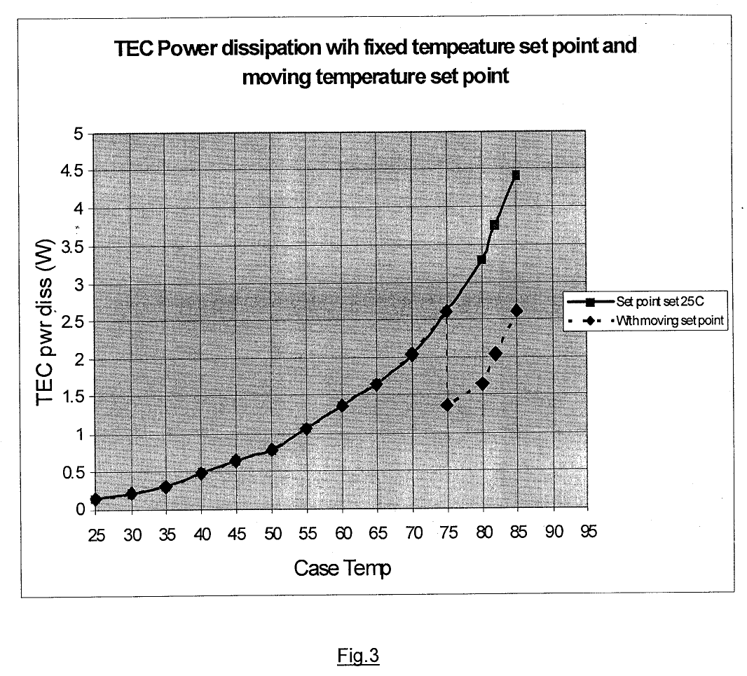

The graph of FIG. 3 showing the TEC power dissipation against the case temperature illustrates the advantage of such a control arrangement in which the temperature set point is changed, by comparison with a known arrangement in which the temperature set point is maintained fixed throughout. The solid line curve illustrates the increase in case temperature with increasing TEC power dissipation for the latter case in which the temperature set point remains fixed, and it will be seen that, above 75° C., the curve steepens so that there is an increased chance of thermal runaway occurring. By contrast, in the case of the temperature set point being changed from 25° C. to 40° C. at a case temperature of 75° C. as shown by the broken line curve, the TEC power dissipation immediately decreases and a thermal runaway situation is avoided.

Thus such an arrangement for controlling the cooling current to the TEC provides a “soft fail” in the event of the amplifier running at particularly high operating temperatures. When the temperature set point is raised there is potentially a slight degradation in amplifier performance due to the reduced efficiency of the pump laser, but the system nevertheless continues to function. Any degradation in amplifier performance is recoverable, whereas, if thermal runaway had been allowed to occur, the degradation of amplifier performance would have been permanent. In the event that the temperature of the laser diode is raised, the result will be loss of amplifying efficiency and a shortening of the diode lifetime. If the temperature is raised too high the laser diode may lose its wavelength locking. If this occurs the pump induced gain inhomogeneity would degrade the wavelength dependent gain of the amplifier.

A further advantage of the described control arrangement is that it reduces the overall power consumption of the amplifier which, at high temperature, is dominated by the current drawn by the TEC.

FIG. 4 shows, both graphically and in the first two columns of the accompanying table, variation of the TEC set point with case temperature such that, when the case temperature increases above 75° C., the TEC set point switches from 25° C. to 40° C. as described above. In practice the switch would need a small amount of hysteresis to overcome noise at the case temperature switch point, and the set point would need to be changed slowly to avoid large current spikes in the controller electronics resulting from an abrupt change in temperature set point. The case temperature is measured by a temperature transducer inside the product that is thermally coupled to the case.

Additionally FIG. 4 illustrates, both graphically and in the first and last columns of the accompanying table, an alternative control arrangement in which, when the case temperature increases above 75° C., the TEC set point gradually increases as a function of case temperature from 25° C. to 40° C. as shown by the sloping line in the lower diagram corresponding to the TEC set point variation passing through the intermediate values of 28.675° C., 28.75° C., 32.5° C. and 36.25° C.

The control chip 5 of the arrangement of FIG. 1 further controls the current demand such that, after the case temperature has subsequently been brought down below 75° C., the temperature set point is changed back to the first temperature set point of 25° C., with the immediate result that the cooling current supplied by the current drive circuitry 6 to the TEC 1 is increased. This second temperature set point changeover can be controlled with some hysteresis allowed so as to avoid a situation in which rapid backward and forward changing between the two temperature set points might occur.

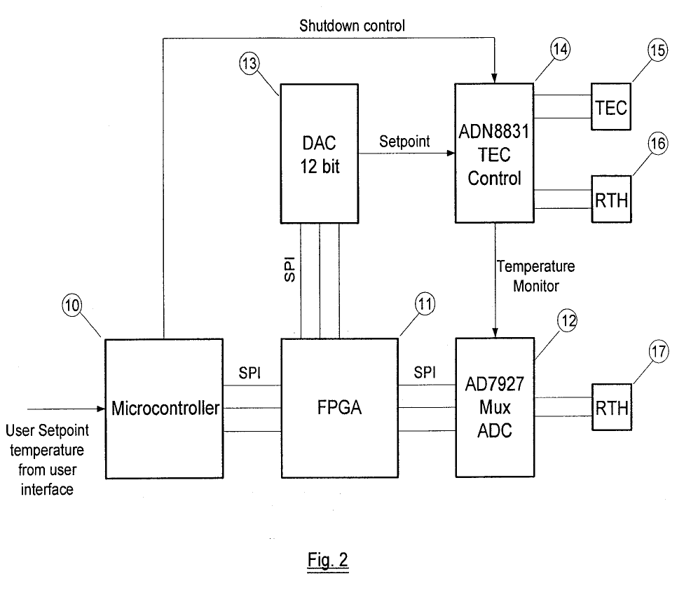

FIG. 2 is a block diagram of a possible hardware implementation of a circuit for controlling the TEC temperature in a second embodiment. The circuit includes a microcontroller 10 to provision temperature set points for the TEC 15 and control the shutdown signal to the TEC controller, and a field programmable gate array (FPGA) 11 to remove the burden of SPI communication from the microcontroller 10 to a digital to analogue converter (DAC) 13 and an ADC 12.

A voltage representing the set point target temperature for the TEC 1 is output from the DAC 13 to a TEC controller IC 14 that includes an analog PI controller, an error amplifier and current drivers. Drive current from the TEC control IC 14 passes through the TEC 15 and causes the temperature of the TEC 15 to reduce for positive drive currents and rise for negative drive currents. The temperature of the laser sub-mount is determined by the TEC controller IC 14 by measuring the resistance of the thermistor 16. The resistance of the thermistor 16 is a function of its temperature and the thermistor 16 is thermally coupled to the laser chip inside the laser package.

The ADC 12 reports back to the microcontroller 10 values for both the laser temperature from the thermistor 16 and the case temperature from a further thermistor 17. With the microcontroller 10 knowing the case temperature it can adjust the value of the temperature set point as a function of the case temperature using an equation or mapping function as already described.

1. An optical amplifier comprising:
an optical fibre;
a pump laser for optically pumping the optical fibre to amplify an optical signal;
a cooler for cooling the pump laser on receipt of a cooling current;
a temperature sensor for monitoring a temperature of the amplifier; and
a control circuit for controlling the cooling current in dependence on a sensing output from the temperature sensor, so as to maintain the temperature of the pump laser at a temperature set point;
wherein the control circuit is configured (i) to maintain the temperature of the pump laser at a first temperature set point within a predetermined temperature range of the amplifier, and (ii) to maintain the temperature of the pump laser at a second temperature set point, higher than the first temperature set point, when the sensing output from the temperature sensor exceeds a threshold value.

2. An optical amplifier according to claim 1, wherein the control circuit is further configured to maintain the temperature of the pump laser at the first temperature set point when the sensing output from the temperature sensor falls below a predetermined value.

3. An optical amplifier according to claim 2, wherein the predetermined value corresponds to the threshold value.

4. An optical amplifier according to claim 1, wherein the control circuit is further configured to vary the temperature of the pump laser in accordance with a variable temperature set point when the sensing output from the temperature sensor exceeds the threshold value, until the temperature of the pump laser reaches the second temperature set point.

5. An optical amplifier according to claim 4, wherein the control circuit is further configured to gradually increase the temperature of the pump laser when the sensing output from the temperature sensor exceeds the threshold value, until the temperature of the pump laser reaches the second temperature set point.

6. An optical amplifier according to claim 1, wherein the threshold value corresponds to a temperature in the range of 50° C. to 85° C., preferably in the range of 70° C. to 80° C., and most preferably of about 75° C.

7. An optical amplifier according to claim 1, wherein the first temperature set point is in the range of 20° C. to 30° C., and preferably of about 25° C.

8. An optical amplifier according to claim 1, wherein the second temperature set point is in the range of 35° C. to 45° C., and preferably of about 40° C.

9. An optical amplifier according to claim 1, wherein the cooler is a thermo-electric cooler.

10. A method of controlling an optical amplifier having an optical fibre, a pump laser for optically pumping the optical fibre to amplify an optical signal, and a cooler for cooling the pump laser on receipt of a cooling current, the method comprising controlling the cooling current in dependence on a sensed temperature of the amplifier so as (i) to maintain the temperature of the pump laser at a first temperature set point within a predetermined temperature range of the amplifier, and (ii) to maintain the temperature of the pump laser at a second temperature set point, higher than the first temperature set point, when the sensed temperature exceeds a threshold value.

11. An optical amplifier according to claim 10, wherein the temperature of the pump laser is gradually increased when the sensing output from the temperature sensor exceeds the threshold value, until the temperature of the pump laser reaches the second temperature set point.

12. A method according to claim 10, wherein the current supplied to the cooler is further controlled to maintain the temperature of the pump laser at the first temperature set point when the sensed temperature falls below the threshold value.
